(19) United States
(12) Patent Application Publication
(10) Pub. No.: US 2020/0045304 A1
(43) Pub. Date: Feb. 6, 2020

(54) METHODS AND SYSTEMS FOR RESOLUTION MEASUREMENT AND CALIBRATION

(71) Applicant: Ferrand D.E. Corley, Mississauga (CA)

(72) Inventor: Ferrand D.E. Corley, Mississauga (CA)

(21) Appl. No.: 16/529,318

(22) Filed: Aug. 1, 2019

Related U.S. Application Data
(60) Provisional application No. 62/713,644, filed on Aug. 2, 2018.

(51) Int. Cl. H04N 17/06; G06T 7/00; H04N 17/00

(52) U.S. Cl. CPC H04N 17/06; G06T 2207/30168; H04N 17/002; G06T 7/001

(57) ABSTRACT

There is disclosed herein methods for measuring reproducing capability of image recording and reproducing devices. The method includes generating an image of a test panel, wherein the image was captured by a test device (e.g., capturing the test image with the test device and uploading the same to a computer processing device; or electronically receiving the test image at a processing device). The image comprises a digital image including therein the test panel. The image is compared to a reference image of a reference panel.

### CROSS REFERENCE TO RELATED APPLICATIONS

This application claims priority to U.S. Provisional Patent Application No. 62/713,644, the contents of which are hereby incorporated herein by reference in their entirety.

### FIELD OF THE INVENTION

The invention relates to the testing, maintenance and adjustment of components used in image acquisition and display, such as cameras, monitors, projectors and printers, to ensure accurate reproduction, interpretation of images.

### BACKGROUND OF THE INVENTION

Resolution and reproduction of fine detail is vitally important in an image reproduction system. Image resolution is typically defined in terms of the number of individual elements, or pixels that can be identified relative to the total image width. While standards vary, 50% of the horizontal screen resolution is typically the maximum number of elements that can be resolved (because, to view a single pixel requires that the adjacent pixels be turned off). Further, a viewed image can only be as good as the lowest common denominator in the chain of devices used in the production and reproduction of the image.

Accurate color reproduction is also important as it permits use of imagery for better identification of items displayed therein (e.g., humans, vehicles, clothing, etc.). However, in many systems, including many security cameras, colors are not accurately reproduced. This can be a result of deficiencies of the image capture devices, processing of the same, and issues related to lighting or other environmental conditions that complicate accurate interpretation of image contents. In some scenarios, security or other monitoring camera imagery (e.g., body camera imagery captured by law enforcement officers or others; dash camera footage; etc.) is captured on a 24 hour per day basis and sent to a central location for viewing, storage and interpretation (as advances in data compression and storage have facilitated storage of video and image data in volumes thought far too cumbersome and costly to store). Such imagery is captured under a variety of lighting, weather and other environmental or situational conditions which impact the fidelity of the captured images. Further, calibration of such devices is fluid over time as image capturing capabilities can degrade or at least change, meaning an initial calibration is of limited use when reviewing imagery from a later time. Such imagery may be reviewed to ascertain details of the objects viewed therein including, for example, the appearance of persons, their clothing, vehicles, and the like. All such details, if accurately represented, can be of great use; but, where inaccurate, or improperly interpreted based on misleading display conditions, can provide little assistance.

Known approaches to solving or alleviating these problems require complex technology and image processing, necessitating high degrees of operator skill, all coming at great expense. As such, they are not practical in high volume image capture scenarios (e.g., body cameras, security cameras, etc.).

There is also a high volume of available image capture device options, such that a simple means of comparing the performance of such devices would be of use. This can be of particular concern in deployment scenarios where a large volume of the chosen device will be purchased (e.g., again, law enforcement body cameras, vehicle cameras; large monitoring environment security cameras; etc.).

Existing systems and methods of using calibration and test patterns require the camera to be precisely framed on the chart, which takes additional time and requires some measure of operator skill. Further, known calibration or test patterns need to be photographed from a level or square perspective, which is inconsistent with the position of most image capture devices when actually deployed. Also, known calibration or test patterns do not provide meaningful data when photographed anywhere other than the center of frame, again creating issues vis-à-vis ease of use. There is thus a need for apparatuses and methods providing tools and technology enabling relatively unskilled individuals optimize and facilitate interpretation of contents of captured images, including facilitating image reproduction with maximal accuracy and fidelity.

### BRIEF SUMMARY OF THE INVENTION

There is disclosed herein methods for measuring reproducing capability of image recording and reproducing devices. The method includes generating an image of a test panel, wherein the image was captured by a test device; comparing the image to a reference image of a reference panel, wherein the reference panel is substantially identical to the test panel and the reference image displays a known set of image traits;

reporting on one or more of the image traits of the test image and related performance of the test device based on the comparing.

In another disclosed aspect, the image comprises a digital image including therein the test panel.

In another disclosed aspect, the generating comprises capturing the test image with the test device and uploading the same to a computer processing device.

In another disclosed aspect, the generating comprises electronically receiving the test image at a processing device.

In another disclosed aspect, the comparing comprises superimposition of the reference image over the test image to align the test panel and reference panel shown therein.

In another disclosed aspect, the comparing comprises determining the resolution of the test image based on a quantity of reference indicia clearly visible therein.

In another disclosed aspect, the comparing further comprises determining a resolving power of the test device via the quantity.

In another disclosed aspect, the result comprises details of differences between the image traits of the test panel in the test image and the reference panel in the reference image.

In another disclosed aspect, the details comprise one or more of image resolution, gray tone composition, color composition, dynamic range, and acutance.

There is also disclosed herein systems for measuring the reproducing capability of image recording and reproducing systems comprising: a test panel bearing resolution data comprising a plurality of areas wherein each of the areas comprises one or more reference indicia indicative of image traits.

In another disclosed aspect, the reference indicia comprises vertically and/or horizontally oriented bars, spaced to permit determinations of resolution based on the visibility thereof in images of the test panel.

In another disclosed aspect, the reference indicia comprises a plurality of blocks of alternating or differing colors positioned substantially around a periphery of the test panel.

In another disclosed aspect, the plurality comprises in the range of three to twelve blocks.

In another disclosed aspect, the alternating or differing colors comprise alternating black and white.

In another disclosed aspect, the plurality comprises five blocks each having defined thereon a grid pattern comprising twenty substantially equally spaced units.

In another disclosed aspect, the units are substantially square in shape.

In another disclosed aspect, the reference indicia further comprises indicia of one or more image traits wherein the traits comprise image resolution, gray tone composition, color composition, dynamic range, and acutance.

In another disclosed aspect, the test panel is substantially octagonal in shape and wherein the blocks are provided one each on a side of the test panel, at or parallel to an edge of the respective ones of the sides.

In another disclosed aspect, the test panel is substantially circular in shape, and wherein the blocks comprise concentric circles evenly spaced from a centre of the test panel.

In another disclosed aspect, the reference indicia further comprises a plurality of segments adjacent the circles and distal from the center of the panel.

### DRAWINGS

The invention is described by way of illustration with reference to the accompanying drawings in which:

FIG. 1 is a front elevation view of a test or reference panel;

FIG. 2 is a front view of a rendering of a security camera image;

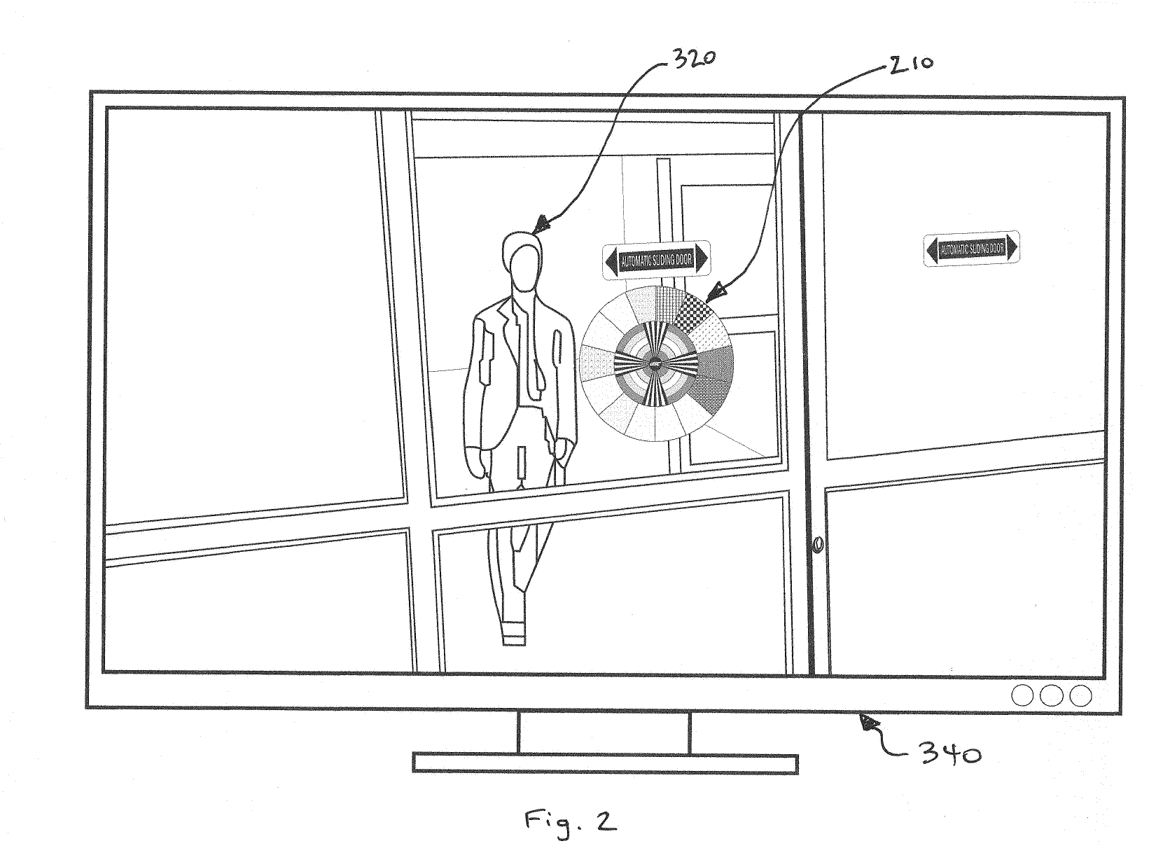

FIG. 3 is front view of the image of FIG. 2 with a digital checkerboard pattern overlaid;

FIG. 4 is a front view of an image resolution determination grid;

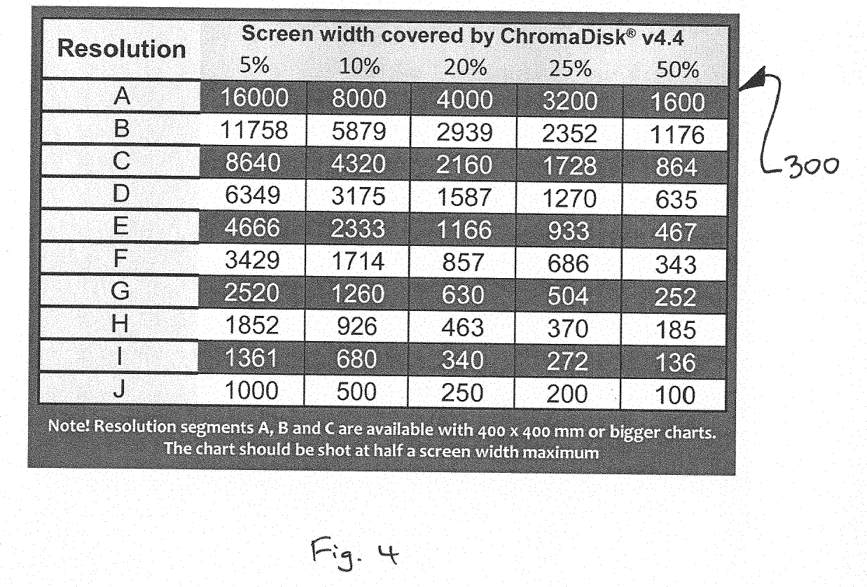

FIG. 5 is a front elevation view of a second test or reference panel;

FIG. 6A is a front elevation view of a third test panel;

FIG. 6B is a front elevation representation of superimposition of the third test panel of FIG. 6A over a third reference image;

FIG. 6C is a front elevation view of a third reference image;

FIG. 7A is a front elevation view of a fourth test panel;

FIG. 7B is a front elevation representation of superimposition of the fourth test panel of FIG. 7A over a fourth reference image;

FIG. 7C is a front elevation view of a fourth reference image.

### DETAILED DESCRIPTION

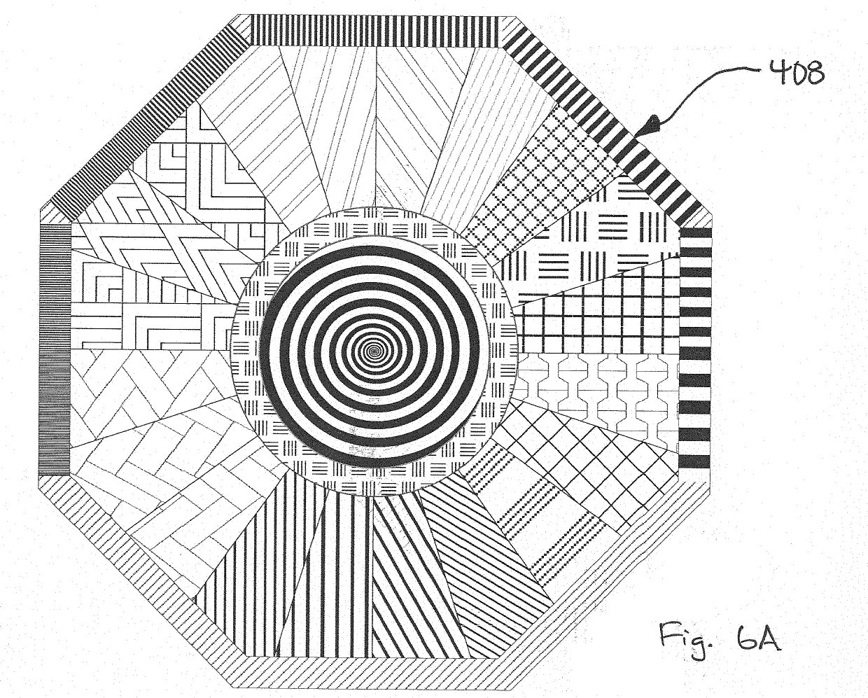

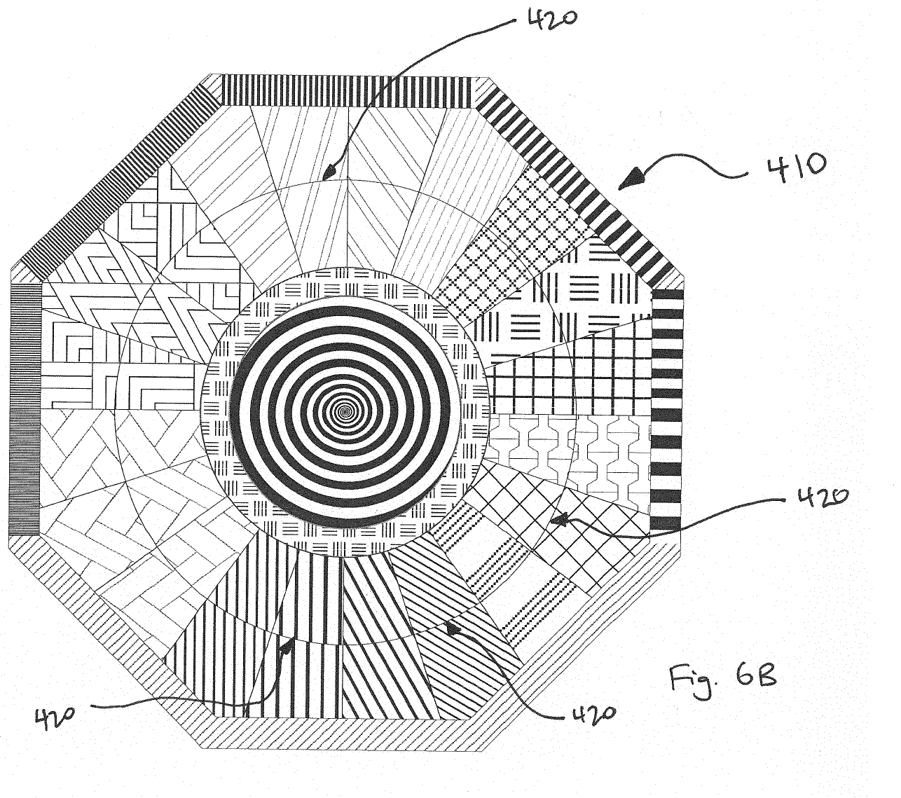

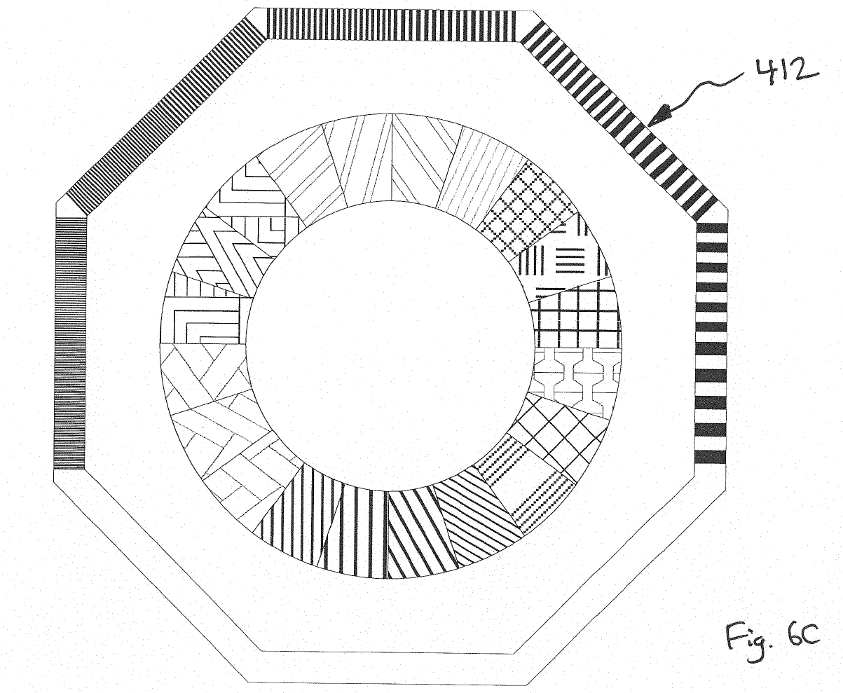

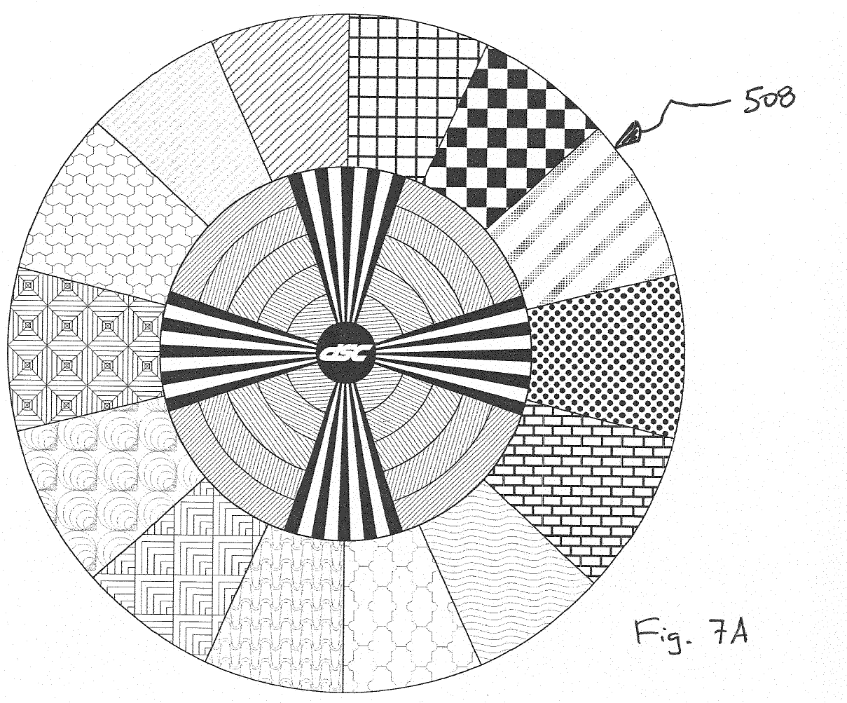

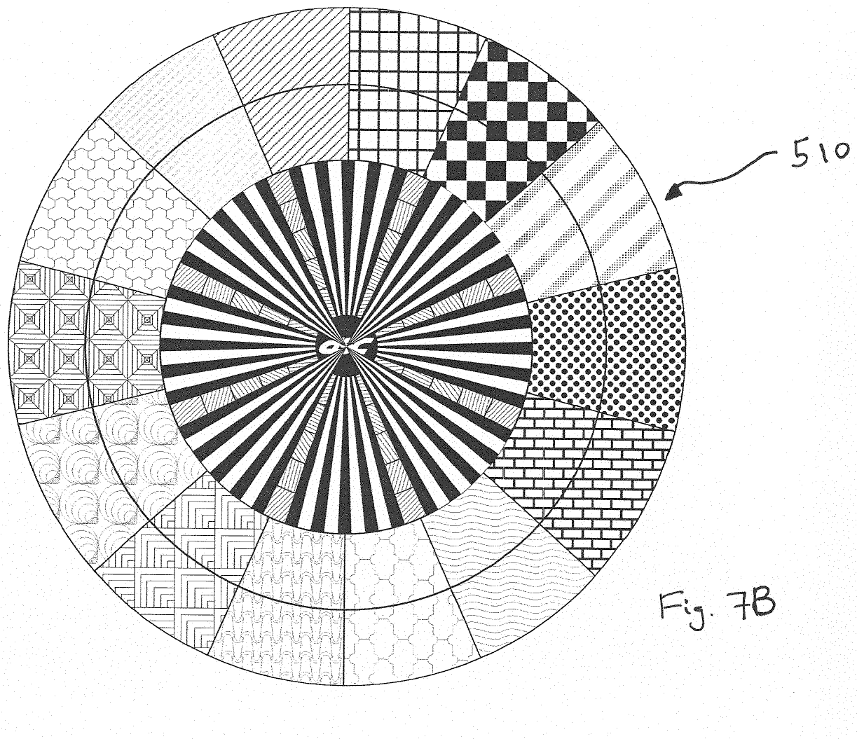

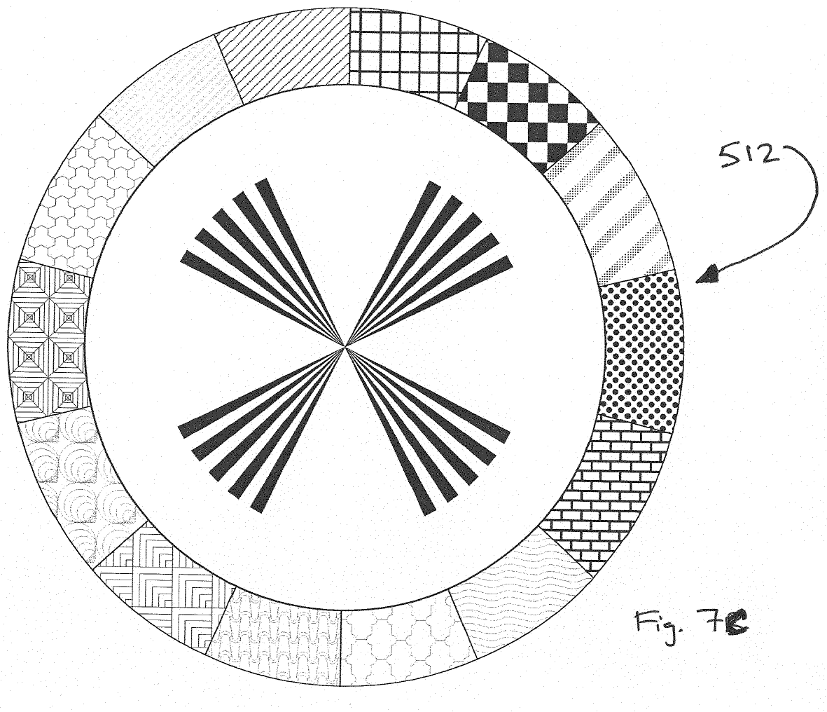

There is disclosed herein methods for measuring reproducing capability of image recording and reproducing devices. The method includes generating a test image 100 of a test panel 110, wherein the test image 100 was captured by a test device (e.g., capturing the test image 100 with the test device and uploading the same to a computer processing device; or electronically receiving the test image 100 at a processing device). The test image 100 comprises a digital image including therein the test panel 110. The test image 100 is compared to a reference image 120 of a reference panel 130—e.g., via superimposition of the reference image 120 over the test image 100 to align the test panel 110 and reference panel 130 shown therein. FIGS. 6 A-C and 7A-C each represent images of test panels (FIGS. 6A and 7A), a superimposition of the test images over a reference image (FIGS. 7A and 7B) and the references images themselves (FIGS. 6C and 7C). The reference panel 130 may generally be substantially identical to the test panel 110 and the reference image 120 displays a known set of image traits.

Looking to FIGS. 6A-C and 7A-C, and particularly 6B and 7B, one skilled in the art will appreciate the image issues apparent from the superimpositions. These include misaligned patterns/colors, which are intended to be examples of issues that may arise when visually or digitally inspecting the superimposition-based comparison. Based on the apparent issues (e.g., misalignment between portions of segments visible in FIGS. 6B and 7B, correction can be applied (e.g., via software).

One or more of the image traits of the test image 100 are reported on in the form of related performance of the test device based on the comparing (e.g., as described above). In some embodiments, the comparing comprises determining the resolution of the test image 100 based on a quantity of reference indicia 140 clearly visible (i.e., sufficiently in focus, as described herein) in the test image 100. The comparing may also include determining a resolving power of the test device via the quantity of reference indicia 140. The result includes details of differences between the image traits of the test panel 110 in the test image 100 and the reference panel 130 in the reference image 120. Such details may include, for example, one or more of image resolution, gray tone composition, color composition, dynamic range, and acutance.

There is also disclosed herein systems 200 for measuring the reproducing capability of image recording and reproducing systems comprising: the test panel 110 bearing resolution data 142 comprising a plurality of areas 144 wherein each of the areas comprises one or more reference indicia 140 indicative of image traits. The reference indicia 140 comprises vertically and/or horizontally oriented bars 146, spaced to permit determinations of resolution based on the visibility thereof in images of the test panel 110.

The reference indicia 140 may also comprise a plurality of blocks 148 of alternating or differing colors (e.g., alternating black and white) positioned substantially around a periphery 112 of the test panel 110. Between three to twelve blocks 148 may be provided, depending on the parameters of the particular embodiment (with five blocks 148 being preferred in some disclosed embodiments).

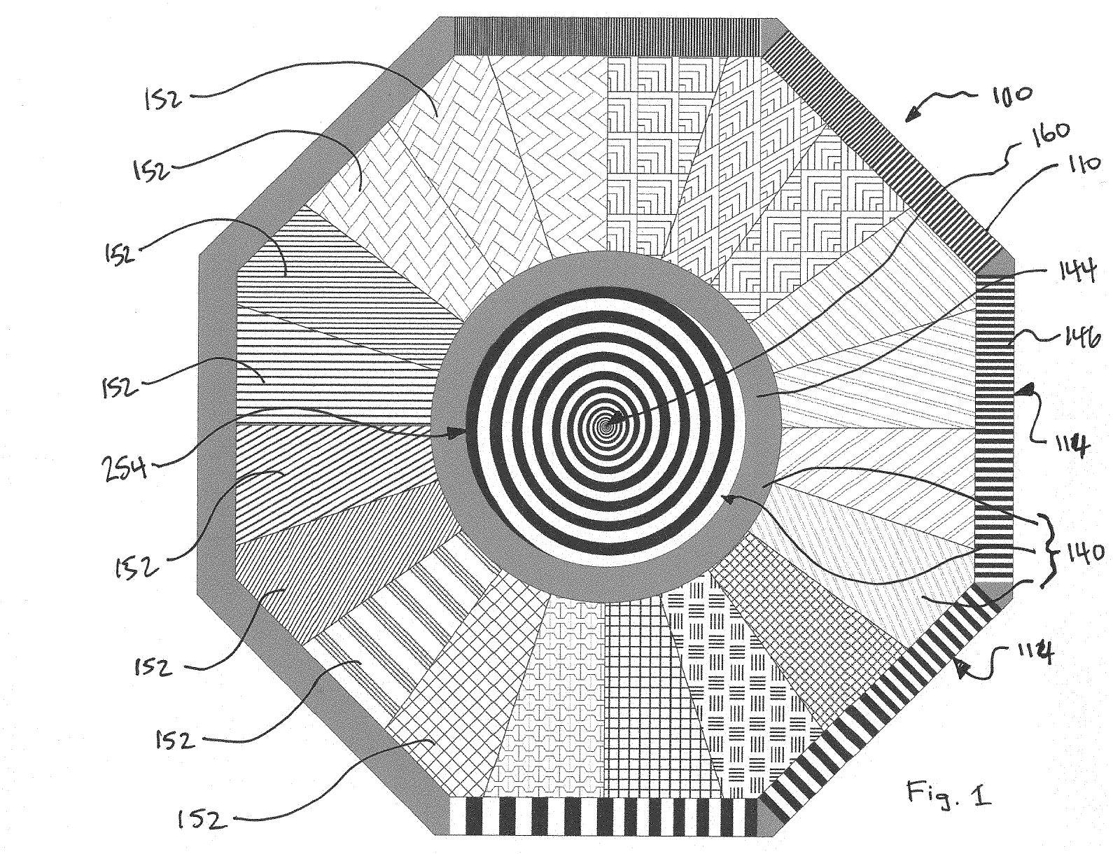

The blocks 148 may each have defined thereon a grid pattern comprising substantially equally spaced units 148a, in some embodiments, twenty of the same (see: FIG. 1), and all or substantially all substantially square in shape.

The reference indicia 140 may also include indicia of one or more image traits wherein the traits comprise image resolution, gray tone composition, color composition, dynamic range, and acutance.

Test panel 110 geometry and shaping may vary from embodiment to embodiments with substantially octagonal shaping employed in some embodiments, and as shown in FIG. 1. This allows for positioning the test panel 110 on various ones of its edges 114 whilst still providing reference indicia 140 in vertical and horizontal orientation to permit various resolution based assessments with great precision. The blocks 148 may be one each on side of the test panel (see FIG. 1), at or parallel to an edge 114 of the respective ones of the sides.

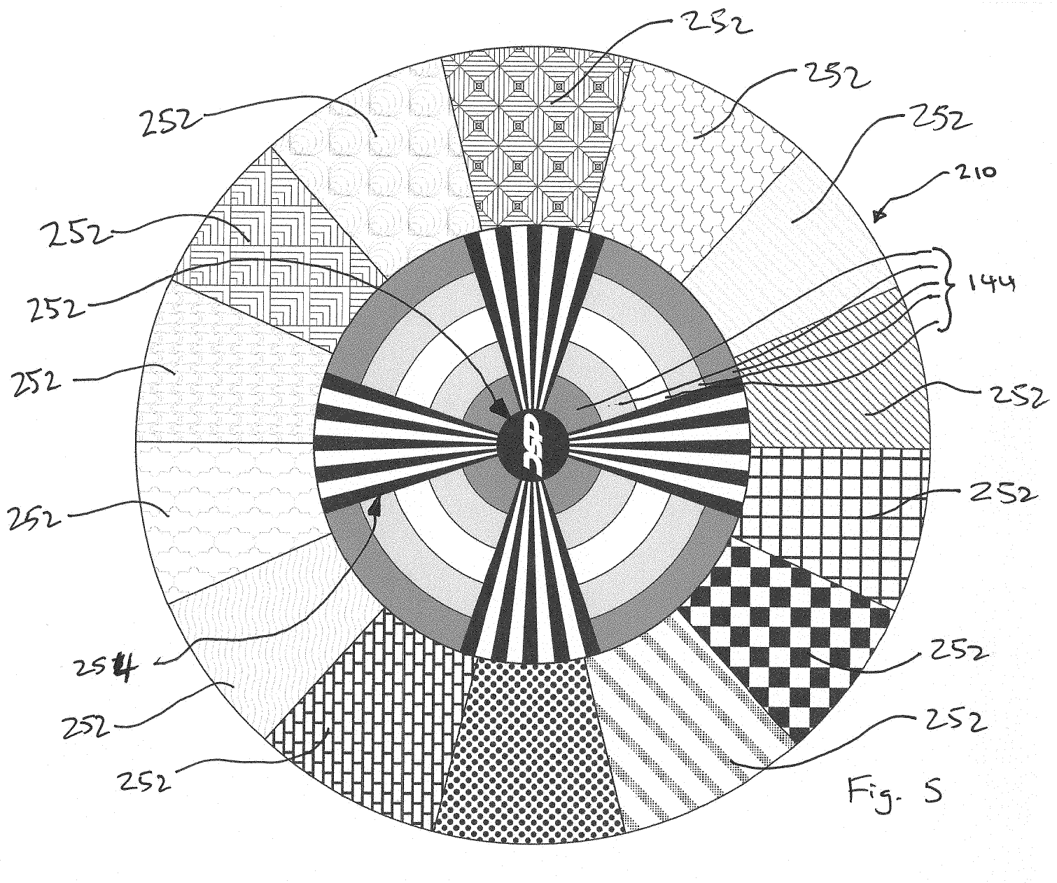

In other embodiments, the test panel 210 may be substantially circular in shape (see: FIG. 5), and the blocks 248 may include concentric circles 248 evenly spaced from a center 250 of the circular test panel 210.

The reference indicia 140, 240 may also include a plurality of segments 152, 252 adjacent the interior of the panel 110, 210 (e.g., the circles in FIG. 5, or the spiral in FIG. 1), and, in some cases, distal from the center of the panel 110, 210.

Segments 152, 252 may be provided in different patterns or colors to provide a further frame of reference for the comparing. One skilled in the art will appreciate that various colors may be used, with the comparison to a reference image including the same colors (accurately rendered) being of value in assessing the test image 100 (e.g., for color correction purposes related to lighting or other influential factors). The reference panel 130 maybe substantially identical to the test panel 110, and provided as a digital image of at least a minimum resolution. The minimum resolution exceeds that of the test image 100, and the reference image 120, is for use in a comparison with the test image with the comparison yielding details of the device's performance in respect of one or more image traits.

The generating may include positioning the test panel 110, 210 within view of at least one camera, which positioning may be substantially permanent (e.g., in deployed environments where the test panel is in view of at least one security camera). In other embodiments, the test panel 110, 210 may be temporarily positioned in the view of the camera to create the test image. The reference image comprises an image of the reference panel (which is substantially identical or the test panel) captured the same or a second camera.

The test panel 110, 210 should be sized and operatively positioned such that it covers at least 10% of the field of view of the first camera in the test image. The reference indicia 140, 240 may further comprises a spiral pattern 254 originating substantially at the centre of the test panel 110. The test image 100 is captured with the first camera positioned within about less than 45° from normal to the test panel 110.

In the test image 100, the test panel 110 may be positioned in a region of interest with a view to assessing performance of the device in that area (e.g., at the periphery of the image; at a location of foremost or particular interest for a given application). The test panel 110 need not be centered and can, in use, be anywhere within the camera's field of view (subject to any constraints recited herein). This is particularly useful in comparing image resolution at the sides and corners of a camera's field of view (or of different devices in such areas).

Image analysis disclosed herein may also include opening the test image 100 from a camera in a computer system capable of display resolution at least equal to a display resolution of the camera. The test image 100 is then reviewed based on one or more reference indicia 140 visible in the test image 100. The reference indicia 140 may be as described herein, and include a number of bars individually visible in the test image 100. Determination of a quantity of image grid squares covered in the test image 100 by a reference dimension of the test panel 110, and comparing the number and the quantity to a set of reference values (see, for example, the chart at FIG. 5) may be used to determine a resolution of the test image 100.

Disclosed systems and methods also provide assistance in optimizing image quality from images previously recorded by security or other cameras. In such cases, placing the test panel 110 in the field of view of the camera that recorded the original images and, photographing when lighting conditions are similar to the conditions under which the original images were recorded, and recording such images of the test panel for the purposes of comparisons of the sort described herein.

Computer-based editing equipment may be used, with data from digital reference files to establish the original camera's deviations from accurate image reproduction. Correction factors may then be used to correct the test image 100 to the original image(s). This sort of comparison is also useful in comparing and evaluating cameras—both security and hand held varieties, for their reproduction capabilities.

In such comparisons, resolution values and differences in other image traits (as described herein) can be made readily available (in some embodiment, this may be provided by way of mobile application software). This sort of comparison may eliminate the need to use expensive resolution test charts and employ time consuming processes of setting up the charts at prescribed distances to ensure efficacy of any related analyses (e.g., to fill the entire frame with the test pattern or other, old methods).

Looking again to FIG. 1 there is shown one embodiment of an octagonal test panel 110 that has five different blocks of resolution gratings at varying levels of resolution, two vertical, one horizontal and two at 45°. The width of the narrowest grating element is based on the width of the test panel 110. In this configuration, the test panel 110 is about 200 mm wide and the width of the finest grating is 0.5 mm or 400 grating elements across.

In the five blocks 148 of gratings, the individual grating widths double in each block. Using a clock face metaphor, the individual grating width in the nine o'clock block is 0.5 mm, the 10.30 is 1.00 mm, the 12 o'clock is 2 mm, the 1.30 o'clock is 4 mm and the 3.00 o'clock is 8 mm.

It is both appropriate and convenient to relate the resolution gratings in the test panel 110 to pixels in a digital imaging system. Other image control elements reside in the center of the test panel 110.

A function of test panel 110 is to provide comprehensive image control elements that enable an operator, using standard editing equipment and procedures to adjust, correct and enhance video and still images so that the viewed image is an accurate reproduction of an original photographed scene.

This is achieved by, as described herein, including test panel 110 in images being photographed. By adjusting the reference elements in test panel 110 so that they reproduce accurately, ensures optimum accuracy in the reproduction of other elements in the scene.

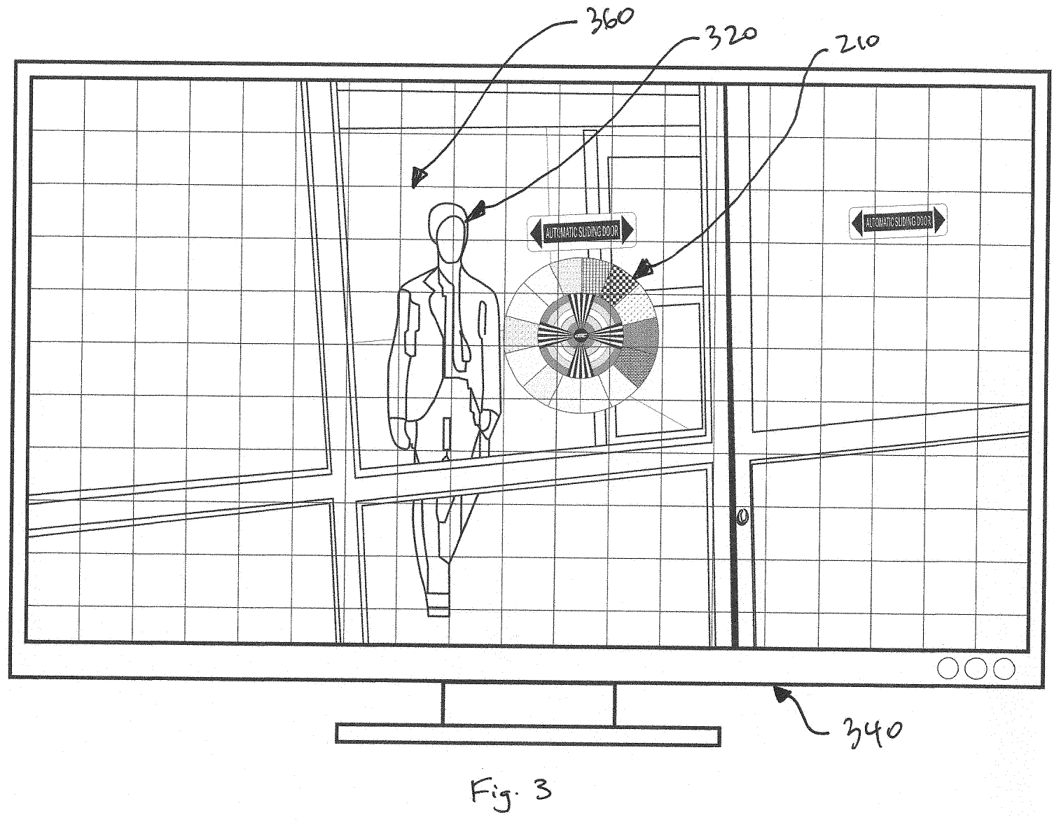

An operator, sitting at a console or otherwise operatively positioned to utilize disclosed systems and/or methods, views images generated by cameras that include test panel 110. To measure the resolution capability of a camera, or image display, the operator views the scene containing test panel 110 on a high-resolution monitor and superimposes a digital grid (see FIG. 3). Then using, for example, dedicated image enhancing and sharpening tools in editing software, the operator enters details of the grating pattern displaying the maximum number of visually focused and identifiable separate lines in resolution blocks. In this case. B is entered, along with the number of grid squares covered by test panel 110, for example 2.5 is the number of squares. The system then calculates (e.g., via mobile application or desktop software implementations), calculates and displays the true resolution capability of the camera, or image display.

The foregoing is a description of a preferred embodiment of the invention which is given here by way of example only. While various embodiments in accordance with the principles disclosed herein have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

It will be understood that the principal features of this disclosure can be employed in various embodiments without departing from the scope of the disclosure. Those skilled in the art will recognize, or be able to ascertain using no more than routine experimentation, numerous equivalents to the specific procedures described herein. Such equivalents are considered to be within the scope of this disclosure and are covered by the claims.

Additionally, the section headings herein are provided as organizational cues. These headings shall not limit or characterize the invention(s) set out in any claims that may issue from this disclosure. Specifically and by way of example, although the headings refer to a “Field” such claims should not be limited by the language under this heading to describe the so-called technical field. Further, a description of technology in the “Background” section is not to be construed as an admission that technology is prior art to any invention(s) in this disclosure. Neither is the “Summary” to be considered a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”). “including” (and any form of including, such as “includes” and “include”) or “containing” (and any form of containing, such as “contains” and “contain”) are inclusive or open-ended and do not exclude additional, un-recited elements or method steps.

All of the devices, systems and/or methods disclosed and claimed herein can be made and executed without undue experimentation in light of the present disclosure. While the compositions and methods of this disclosure have been described in terms of preferred embodiments, it will be apparent to those of skill in the art that variations may be applied to the compositions and/or methods and in the steps or in the sequence of steps of the method described herein without departing from the concept, spirit and scope of the disclosure. All such similar substitutes and modifications apparent to those skilled in the art are deemed to be within the spirit, scope and concept of the disclosure as defined by the appended claims.

1. A method for measuring reproducing capability of image recording and reproducing devices, the method comprising:
(a) generating an image of a test panel, wherein the image was captured by a test device;
(b) comparing the image to a reference image of a reference panel, wherein the reference panel is substantially identical to the test panel and the reference image displays a known set of image traits;
(c) reporting on one or more of the image traits of the test image and related performance of the test device based on the comparing.

2. A method according to claim 1, wherein the image comprises a digital image including therein the test panel.

3. A method according to claim 1, wherein the generating comprises capturing the test image with the test device and uploading the same to a computer processing device.

4. A method according to claim 1, wherein the generating comprises electronically receiving the test image at a processing device.

5. A method according to claim 1, wherein the comparing comprises superimposition of the reference image over the test image to align the test panel and reference panel shown therein.

6. A method according to claim 1, wherein the comparing comprises determining the resolution of the test image based on a quantity of reference indicia clearly visible therein.

7. A method according to claim 6, wherein the comparing further comprises determining a resolving power of the test device via the quantity.

8. A method according to claim 1, wherein the result comprises details of differences between the image traits of the test panel in the test image and the reference panel in the reference image.

9. A method according to claim 6, wherein the details comprise one or more of image resolution, gray tone composition, color composition, dynamic range, and acutance.

10. A system for measuring the reproducing capability of image recording and reproducing systems, the system comprising:
(a) a test panel bearing resolution data comprising a plurality of areas wherein each of the areas comprises one or more reference indicia indicative of image traits.

11. A system according to claim 10, wherein the reference indicia comprises vertically and/or horizontally oriented bars, spaced to permit determinations of resolution based on the visibility thereof in images of the test panel.

12. A system according to claim 10, wherein the reference indicia comprises a plurality of blocks of alternating or differing colors positioned substantially around a periphery of the test panel.

13. A system according to claim 12, wherein the plurality comprises in the range of three to twelve blocks.

14. A system according to claim 12, wherein the alternating or differing colors comprise alternating black and white.

15. A system according to claim 13, wherein the plurality comprises five blocks each having defined thereon a grid pattern comprising twenty substantially equally spaced units.

16. A system according to claim 15, wherein the units are substantially square in shape.

17. A system according to claim 11, wherein the reference indicia further comprises indicia of one or more image traits wherein the traits comprise image resolution, gray tone composition, color composition, dynamic range, and acutance.

18. A system according to claim 10, wherein the test panel is substantially octagonal in shape and wherein the blocks are provided one each on a side of the test panel, at or parallel to an edge of the respective ones of the sides.

19. A system according to claim 10, wherein the test panel is substantially circular in shape, and wherein the blocks comprise concentric circles evenly spaced from a center of the test panel.

20. A system according to claim 19, wherein the reference indicia further comprises a plurality of segments adjacent the circles and distal from the center of the panel.
